(19) United States
(12) Patent Application Publication
(10) Pub. No.: US 2022/0413573 A1
(43) Pub. Date: Dec. 29, 2022

(54) HARDWARE COMPONENT TEMPERATURE CONTROL

(71) Applicant: HEWLETT-PACKARD DEVELOPMENT COMPANY, L.P., Spring, TX (US)

(72) Inventors: Iring Chiu, Taipei (TW); Cheng-Yan Chiang, Taipei (TW); Bing-Hao Cheng, Taipei (TW)

(73) Assignee: HEWLETT-PACKARD DEVELOPMENT COMPANY, L.P., Spring, TX (US)

(21) Appl. No.: 17/361,735

(22) Filed: Jun. 29, 2021

(51) Int. Cl. G06F 1/20; G06F 1/26; G01K 3/00

(52) U.S. Cl. CPC G06F 1/206; G06F 1/26; G01K 3/005

(57) ABSTRACT

In an example in accordance with the present disclosure, a compute device is described. The compute device includes a thermal sensor to measure a temperature at a hardware component of the compute device. The compute device also includes a controller. The controller is to determine a threshold temperature for the hardware component. Responsive to a measured temperature being beyond the threshold temperature for the hardware component, the controller is to activate a temperature control element adjacent the hardware component. The compute device also includes the temperature control element adjacent the hardware component to control the temperature of the hardware component.

### BACKGROUND

Compute devices include hardware components that individually or collectively execute a wide variety of computing operations. For example, a compute device may include a processor, a memory device, a graphics card, a sound card, transistors and circuitry to connect these and other hardware components. The interoperation of these hardware components provides a user with a wide variety of computing operations that may be executed. While specific reference is made to particular hardware components in a compute device, a compute device may include any variety of hardware components to allow a user to carry out a variety of intended operations.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a compute device for hardware component temperature control, according to an example of the principles described herein.

FIG. 2 is a flowchart of a method for controlling the temperature of a hardware component in a compute device, according to an example of the principles described herein.

FIG. 3 is a diagram of a compute device for hardware component temperature control, according to an example of the principles described herein.

FIG. 4 is a diagram of a compute device for hardware component temperature control, according to an example of the principles described herein.

FIG. 5 is a flowchart of a method for controlling the temperature of a hardware component in a compute device, according to an example of the principles described herein.

FIG. 6 is a diagram of a compute device for hardware component temperature control, according to an example of the principles described herein.

FIG. 7 is a diagram of a compute device for hardware component temperature control, according to an example of the principles described herein.

FIG. 8 depicts a non-transitory machine-readable storage medium for controlling the temperature of a hardware component in a compute device, according to an example of the principles described herein.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations that coincide with the description; however, the description is not limited to the examples and/or implementations provided in the drawings.

### DETAILED DESCRIPTION

Compute devices are used by millions of people daily to carry out business, personal, and social operations and it is not uncommon for an individual to interact with multiple compute devices on a daily basis. Examples of compute devices include desktop computers, laptop computers, all-in-one devices, tablets, and gaming systems to name a few. A compute device may include any number of hardware components. These hardware components operate with other hardware components to execute a function of the compute device. For example, a memory device may include instructions that are executable by a processor. The instructions when executed by the processor, may cause the processor to execute an operation on the compute device. As a specific example, the compute device may include a central processing unit (CPU) and/or a graphics processing unit (GPU). The compute device also includes circuitry to interconnect the hardware components. While specific reference is made to particular hardware components, a compute device may include any number and any variety of hardware components to carry out an intended function of the compute device.

As compute devices are becoming more ubiquitous in society, some developments may further enhance their integration. For example, a hardware component may have an operational temperature range which defines a temperature range wherein the hardware component performs its intended function. If the hardware component temperature is outside of this range, the hardware component performance may be compromised. That is, if the hardware temperature component is higher than an upper bound threshold or lower than a lower bound threshold, performance of the hardware component may be affected. As a result, the compute device in which the hardware component is disposed, may not perform as intended. As such, the present specification provides for a compute device that maintains a hardware component in a particular temperature range, which temperature range may be the operational temperature range for the hardware component.

As a particular example, some compute devices are in a different location than the user input and output devices. In such a system, the compute device includes resources that are stored on a remote terminal rather than on a localized hard drive where a user is interacting with the input and output devices. For example, in a school setting, a library may have any number of workstations that include devices such as a desktop monitor, a keyboard, and a mouse. However, the processor and memory and other hardware components that execute the compute operations may be remote from the workstation. It may be the case that these hardware components, i.e., input/output cards, CPU, GPU, etc. may be in another room. In some examples, these other hardware components may be in another building or may be even tens of kilometers away from the user workspace.

In such an example, the input and output devices at the workstation where the user sits, may communicate with the remote terminal-based compute device via a wired or wireless network connection. In these environments, a wake on LAN (WOL) operation executed at the workstation may boot up the remotely-located compute device. Specifically, responsive to a user input, a specialized packet is transmitted to the compute device. A command from the user, for example activation of a user input device such as a button on a display panel and/or depression of a mouse button or keyboard key, may send the specialized packet to the powered-down compute device. If a specialized packet is received at a powered-down compute device and includes the compute device media access control (MAC) address, the network interface card (MC) may signal the power supply or motherboard to initiate a device wake-up.

However, as described above, the powered-down compute device may be remote from the user, for example in a room or facility that is not temperature-controlled. In this example, a hardware component may initially be at a temperature that is lower than the operational temperature range for the hardware component or may initially be at a temperature that is higher than the operational temperature range for the hardware component. As such, the hardware component and/or the compute device may not operate as intended, or may not operate at all. As such, the present specification describes a compute device that regulates the temperature of hardware components of a compute device to ensure that the hardware components are in a target operational range to perform their intended function, even when the compute device is in a sleep state.

Specifically, the present specification describes a compute device. The compute device includes a thermal sensor to measure a temperature at a hardware component of the compute device. The compute device also includes a controller. The controller is to determine a threshold temperature for the hardware component and responsive to a measured temperature beyond the threshold temperature for the hardware component, activate a temperature control element adjacent the hardware component. The compute device also includes the temperature control element, which is adjacent to the hardware component, and which is to control the temperature of the hardware component.

The present specification also describes a method. According to the method, a thermal sensor measures a temperature in a zone adjacent a hardware component of a compute device. The controller compares a measured temperature against a threshold temperature for the hardware component. Responsive to the measured temperature being beyond the threshold temperature for the hardware component, the controller is to activate a temperature control element adjacent the hardware component.

The present specification also describes a non-transitory machine-readable storage medium encoded with instructions executable by a processor. The machine-readable storage medium includes instructions to, when executed by the processor, cause the processor to 1) measure a temperature in a zone adjacent a hardware component of a compute device, 2) extract a threshold temperature for the hardware component from a database, and 3) compare a measured temperature against the threshold temperature for the hardware component. Responsive to the measured temperature being below the threshold temperature for the hardware component, the instructions, when executed by the processor, cause the processor to close a switch to couple a heating element to a power supply to generate a current through the heating element to raise the temperature of the hardware component. Responsive to the measured temperature rising above the threshold temperature for the hardware component, the instructions, when executed by the processor, cause the processor to open the switch to decouple the heating element from the power supply to stop the current.

In summary, using such a compute device, method, and machine-readable storage medium may, for example, 1) ensure hardware components are within a target temperature range; 2) provide remote activation of a remote compute device; and 3) maintain hardware components within the target temperature range even when the compute device is in a sleep state. However, it is contemplated that the compute devices disclosed herein may address other matters and deficiencies in a number of technical areas, for example.

As used in the present specification and in the appended claims, the term, “controller” includes a processor and a memory device. The processor includes the circuitry to retrieve executable code from the memory and execute the executable code. As specific examples, the controller as described herein may include machine-readable storage medium, machine-readable storage medium and a processor, an application-specific integrated circuit (ASIC), a semiconductor-based microprocessor, and a field-programmable gate array (FPGA), and/or other hardware device.

As used in the present specification an in the appended claims, the term “memory” includes a non-transitory storage medium, which machine-readable storage medium may contain, or store machine-usable program code for use by or in connection with an instruction execution system, apparatus, or device. The memory may take many forms including volatile and non-volatile memory. For example, the memory may include Random-Access Memory (RAM), Read-Only Memory (ROM), optical memory disks, and magnetic disks, among others. The executable code may, when executed by the respective component, cause the component to implement the functionality described herein. The memory may include a single memory element or multiple memory elements.

As used in the present specification and in the appended claims, the term “a number of” or similar language is meant to be understood broadly as any positive number including 1 to infinity.

Further as used in the present specification and in the appended claims, the term “compute device” refers to a compute device which contains resources to execute an operating system. In an example, the compute device may be a host device.

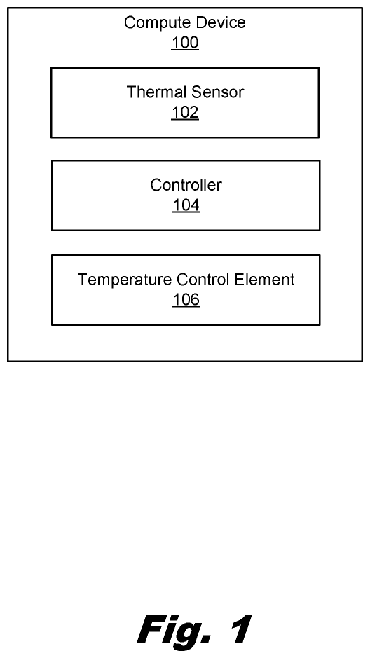

Turning now to the figures, FIG. 1 is a block diagram of a compute device (100) for hardware component temperature control, according to an example of the principles described herein. The compute device (100) may be of a variety of types. For example, the compute device (100) may be a desktop computer, a laptop computer, a server, a tablet device and a gaming system. In a particular example, the compute device (100) may be a distributed system wherein the compute device (100) is remotely located from user input and output devices. In this example, the compute device (100) may be remotely located from a thin client that includes the input and output devices relied on by a user to carry out computing operations. While particular reference is made to specific compute devices (100), the principles described herein may be implemented in a variety of different kinds of compute devices (100).

As described above, the compute device (100) may include a number of hardware components. Each hardware component may have a particular operating temperature range. That is, if the hardware component temperature is outside of this operating temperature range, the hardware component performance may suffer or the hardware component may fail altogether. Taking the WOL operation as an example, a compute device (100) may remotely connect to a display device and an input device. In this example, it may be desired that hardware components such as a system-on-chip (SoC) circuit, super input/output (SIO) circuit, power supply, and network interface card (NIC) among others are within respective operating temperature ranges to ensure the compute device (100) may be correctly booted by a thin client. While particular reference is made to particular hardware components, it may be desirable for other hardware components of a compute device (100) to similarly be maintained within respective operational temperature ranges. Other examples of hardware components that may be found on the compute device (100) include an embedded controller, a GPU, a CPU, and a memory device among others.

Accordingly, the present compute device (100) prevents a hardware component from falling below its lower bound operational temperature or rising above its upper bound operational temperature. Specifically, the compute device (100) includes a thermal sensor (102) to detect the temperature at, or surrounding, a particular hardware component. If the surrounding temperature falls below a certain temperature or rises above a certain temperature, the controller (104) may perform operations to bring or maintain the hardware component in the operational temperature range. For example, the controller (104) may close a switch circuit to provide a temperature control element (106) with an electric current. In an example where the temperature control element (106) is a heating element, the electric current heats up the heating element. The heating element then warms up the hardware component to prevent the hardware component from reaching a non-operational temperature. In an example where the temperature control element (106) is a cooling element, such as a fan, the electric current may cause the fan blades to rotate. While particular reference is made to certain temperature control elements (106) such as a thin-film resistor and a fan, other heating and cooling elements may be implemented, such as a liquid-cooled cooling element. In this example, coupling of the temperature control element (106) in whatever form, to a power supply, may initialize the temperature control functionality of the temperature control element (106).

In some examples, the thermal sensor (102) may be a contact sensor that touches the hardware component. In an example, the thermal sensor (102) may be a thermocouple or a thermistor which contacts the hardware component of which the temperature is to be taken. As another example, the thermal sensor (102) may be a thermally sensitive resistor, which is an electrical resistance component that is sensitive to temperature change. In another example, the thermal sensor (102) is adjacent to, but not contacting, the hardware component. In either case, the thermal sensor (102) measures the temperature and transmits the temperature to a controller (104).

In addition to receiving a measured temperature value, the controller (104) determines a threshold temperature for the hardware component. In some examples, the controller (104) extracts the threshold temperature value from a database stored on the compute device (100). In another example, the controller (104) receives the threshold temperature from a database that is remote from the compute device (100). As described above, different hardware components may have different threshold temperatures. As such, the threshold temperature which is to trigger component temperature control may be based on a variety of factors including geographic location, historic temperature measurements for the region, and/or component-based criteria. In an example, the threshold temperature against which the measured temperature is compared is a lower bound operational temperature range for the hardware component. For example, a hardware component may have an operational temperature range of between 10 degrees Celsius (° C.) and 40 degrees ° C. Accordingly, in this example, the measured temperature from the thermal sensor (102) may be compared against the threshold temperature of 10° C. and a heating element may be activated.

In another example, the threshold temperature may be a buffered lower bound threshold of the operational temperature range for the hardware component. In this example, rather than identifying when the measured temperature falls below 10° C., the controller (104) may determine when the measured temperature falls below 15° C. and may activate the heating element at that point. Doing so may activate the heating element at an earlier point in time as compared to when a 10° C. threshold is met and therefore may prevent the hardware component from reaching a temperature close to where its operation may be affected.

In another example, the threshold temperature may be a higher bound threshold of the operational temperature range for the hardware component. In this example, the measured temperature from the thermal sensor (102) may be compared against the threshold temperature and a cooling element may be activated.

Responsive to a measured temperature being beyond the threshold temperature for the hardware component, the controller (104) activates the temperature control element (106) adjacent the hardware component. That is, the controller (104) may compare a measured temperature against a threshold temperature. If the measured temperature is below the threshold temperature, the controller (104) may activate the heating element. The controller (104) may do so in any number of ways. For example, the controller (104) may transmit an activation signal to the heating element. In another example, the controller (104) may close a switch which provides the heating element with an electric current which causes the heating element to heat up. Similar activation actions may be executed responsive to the measured temperature being above a threshold temperature such that a cooling element is coupled to a power supply.

Accordingly, the compute device (100) includes a temperature control element (106) which is adjacent the hardware component. As described above, the temperature control element (106) may be a heating element or a cooling element. In one example, electric current provided to the heating element causes the heating element to heat up. This heat radiates from the heating element towards the adjacent hardware component to raise the temperature of the hardware component, ultimately to a temperature greater than the lower bound threshold temperature. In an example, the heating element is a thin film resistor formed on a substrate.

In an example, the thermal sensor (102) and the controller (104) are active when the compute device (100) is in a sleep state. That is, when the compute device (100) is active, the hardware components may generate enough heat to maintain themselves above the lower bound temperature threshold and active components may operate to cool the hardware components. It is when the compute device (100) is in a sleep state that these hardware components may cool to below the lower bound temperature threshold or the other cooling components of the compute device (100) are inactive. As such, the compute device (100) may provide power to the thermal sensor (102) and the controller (104) such that these components may continue to take temperature measurements, compare temperature measurements against a threshold temperature, and activate the temperature control element (106), even when a central processing unit (CPU) of the compute device (100) may be powered down. That is, the controller (104) may be separate from the CPU of the compute device (100).

As such, the compute device (100) of the present specification accommodates intended functionality even when the compute device (100), or a portion thereof, is found in an area that is subjected to cold weather conditions or hot weather conditions.

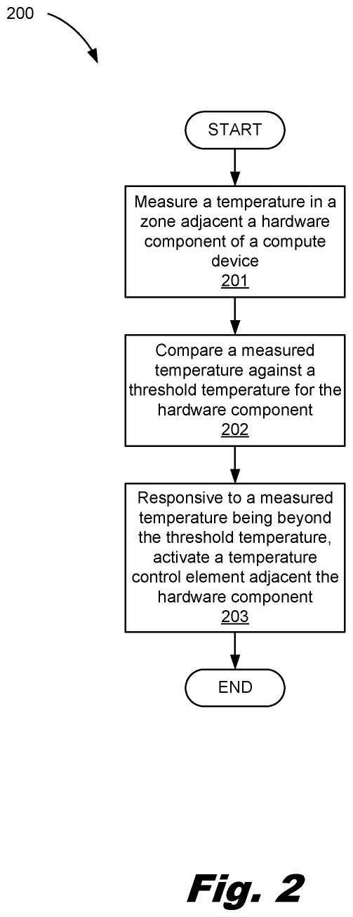

FIG. 2 is a flowchart of a method (200) for controlling the temperature of a hardware component in a compute device (FIG. 1, 100), according to an example of the principles described herein. According to the method (200), a thermal sensor (FIG. 1, 102) measures (block 201) a temperature in a zone adjacent a hardware component of a compute device (FIG. 1, 100). That is, as described above, environmental temperatures may impact the performance of certain hardware components. Accordingly, a thermal sensor (FIG. 1, 102) may be placed adjacent a hardware component to detect when the hardware component temperature has fallen or risen to a level that may impact its performance. Responsive to such a condition, a variety of remedial actions may be taken.

This measured temperature is passed to a controller (FIG. 1, 104) which compares (block 202) the measured temperature against a threshold temperature for the hardware component. As described above, the threshold temperature may be a lower bound of an operational temperature range, a buffered-version of the lower bound of the operational temperature range, or an upper bound of an operational temperature range. Also as described above, the threshold may be determined by any number of criteria including geographic location, component specific criteria, and/or device criteria. This threshold temperature may be stored in a database such that the controller (FIG. 1, 104) may have data by which the controller (FIG. 1, 104) determines whether to activate or deactivate the heating element (FIG. 1, 106).

Responsive to the measured temperature being beyond the threshold temperature for the hardware component, the controller (FIG. 1, 104) activates (block 203) a temperature control element (FIG. 1, 106) adjacent the hardware component to raise the hardware component temperature past a lower bound temperature threshold or to lower the hardware component below the upper bound temperature threshold. Such activation (block 203) may generate an electrical current through a heating element, such as a thin film resistive heater. The electrical current causes the thin film resistive heater to heat up and radiate thermal energy towards the adjacent hardware component to raise the temperature of the hardware component.

In an example, the compute device (FIG. 1, 100) may provide a notification as to a hardware component status. For example, the compute device (FIG. 1,100) may provide a notification that a hardware component is beyond its operational temperature range. In another example, the compute device (FIG. 1, 100) may provide a notification that temperature control is occurring. For example, the compute device (FIG. 1, 100) may select a particular blink pattern for light emitting diodes (LEDs) to indicate the hardware component is being warmed up. In another example, the notification may include an audio output or a modified splash screen sent to a display device to indicate that the hardware component is being heated up prior to booting. While particular reference is made to particular notification mechanisms, a variety of other mechanisms may be implemented to indicate a status of the temperature control components. As such, the present method (200) provides operations that when executed may maintain the hardware component within an operational temperature range, thus ensuring desired and intended hardware component functionality.

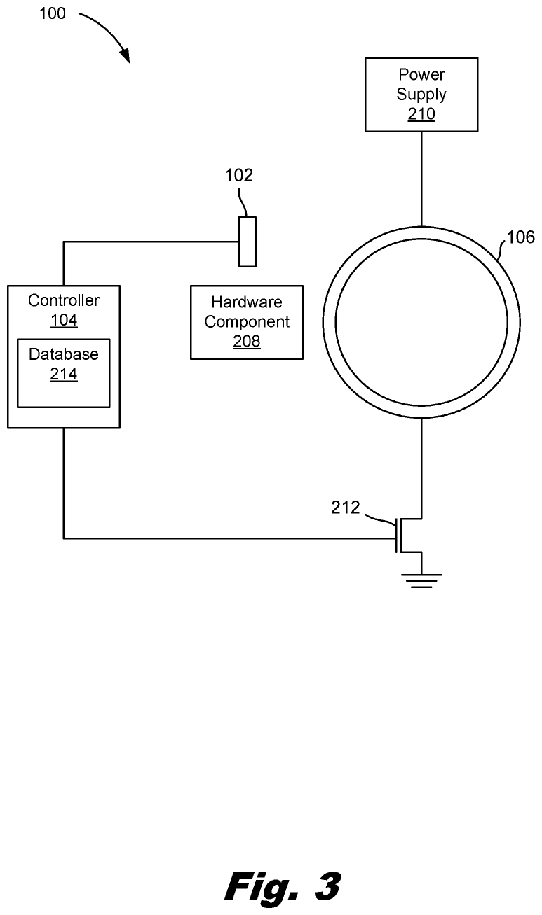

FIG. 3 is a diagram of a compute device (100) for hardware component (208) temperature control, according to an example of the principles described herein. FIG. 3 clearly depicts the thermal sensor (102) which is positioned adjacent the hardware component (208). As described above, the hardware component (210) may be a variety of types. As the thermal sensor (102) is adjacent the hardware component (208), an output of the thermal sensor (102) is indicative of the general temperature of the hardware component itself.

FIG. 3 also depicts the controller (104) which receives the output of the thermal sensor (102) and selectively activates the temperature control element (106). As described above, the threshold temperature value may be stored in a database (214) such that the controller (104) may extract a value therefrom to determine whether to activate the temperature control element (106). In other examples, the controller (104) is to extract the threshold temperature for the hardware component (208) from a remote database.

FIG. 3 also depicts the temperature control element (106). In the example depicted in FIG. 3, the temperature control element (106) may be adjacent the hardware component (208). As described above, the temperature control element (106) may be a heating element that is a thin film resistor having a thickness of greater than 0.1 millimeter (mm) for example. In an example, the thin film heating element may include two plastic sheets covered by a metal coil. In this example, the metal coil may be connected to a power supply (210) and ground through which the electrical current flows.

In an example, the compute device (100) includes a switch (212), which may be a transistor such as a metal oxide semiconductor field effect transistor (MOSFET). The switch (212) is to couple the temperature control element (106) to a power supply (210). As with the controller (104) and thermal sensor (102), the power supply (210) may always be active, even when other components such as a CPU are not. In this example, the power supply (210) may be active so long as the compute device (100) is coupled to alternating current (AC) power. Doing so ensures that even when the compute device (100) is in a sleep state, the temperature control element (106) is capable of warming or cooling the hardware component (208).

In this example, the controller (104) activates the temperature control element (106) by closing the switch (212) such that a closed circuit is formed between the power supply (210) and ground and the temperature control element (106) receives current.

In an example, with the circuit closed, the metal coil of the thin film heating element may generate heat due to the electrical current. The generation of heat at the metal coil may cause the temperature of the entire thin film heating element to rise. Note that while FIG. 3 depicts a particular configuration and geometry for the temperature control element (106), the temperature control element (106) may take a variety of forms.

As such, the present compute device (100) provides a system to ensure that a hardware component (208) of the compute device (100) may be maintained within the operational temperature range for the hardware component (208) so as to ensure the hardware component (208) operates as intended.

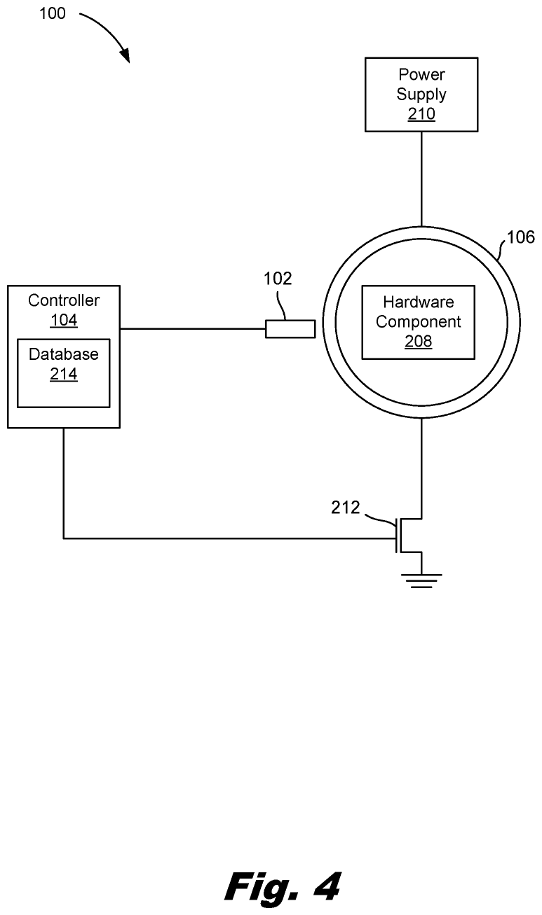

FIG. 4 is a diagram of a compute device (100) for hardware component (208) temperature control, according to an example of the principles described herein. In the example depicted in FIG. 4, the temperature control element (106) surrounds the hardware component (208). That is, the temperature control element (106) surrounds the hardware component (208) on all sides. Doing so may provide uniform temperature as the heat transfer mechanism of the temperature control element (106) applies equally to all sides of the hardware component.

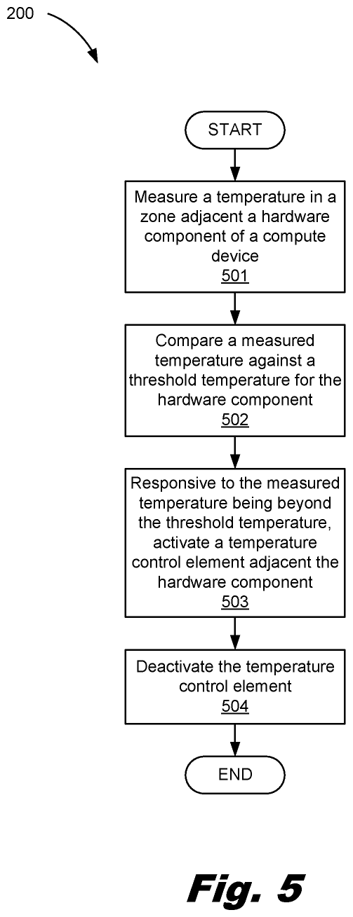

FIG. 5 is a flowchart of a method (500) for controlling the temperature of a hardware component (FIG. 2, 208) in a compute device (FIG. 1, 100), according to an example of the principles described herein. According to the method (500), a temperature in a zone adjacent a hardware component (FIG. 2, 208) is measured (block 501) and compared (block 502) against a threshold temperature for the hardware component (FIG. 2, 208). Responsive to the measured temperature being beyond the threshold temperature, the controller (FIG. 1, 104) may activate (block 503) the temperature control element (FIG. 1, 106) to adjust the temperature of the hardware component (FIG. 2, 208). As described above, such a temperature control may include heating or cooling the hardware component (FIG. 2, 208). These operations may be performed as described above in connection with FIG. 2.

In some examples, the controller (FIG. 1, 104) may deactivate (block 504) the temperature control element (FIG. 1, 106). That is, the temperature control element (FIG. 1, 106) may consume power. Moreover, once activated, the hardware component (FIG. 2, 208) may generate heat. Accordingly, once the hardware component (FIG. 2, 208) rises above a certain threshold temperature, the controller (FIG. 1, 104) may deactivate the temperature control element (FIG. 1, 106) to conserve power as the hardware component (FIG. 2, 208) activity itself, or of other cooling systems which are active during use may maintain the hardware component (FIG. 2, 208) temperature within the operational temperature range. Moreover, maintaining the temperature control element (FIG. 1, 106) in an active state, may cause certain undesirable heating or cooling of the hardware component (FIG. 2, 208) and or other components of the compute device (FIG. 1, 100) to an undesirable temperature.

In an example, the controller (FIG. 1, 104) may deactivate (block 504) the temperature control element (FIG. 1, 106) responsive to the measured temperature rising above the threshold temperature or another temperature. For example, the threshold temperature at which the controller (FIG. 1, 104) activates the heating element may be 10° C. In this example, once the thermal sensor (FIG. 1, 102) indicates that the hardware component (FIG. 2, 208) temperature is greater than 10° C., the controller (FIG. 1, 104) may deactivate (block 504) the heating element as the hardware component (FIG. 2, 208) is operating in a range to perform as intended.

In another example, the controller (FIG. 1, 104) may deactivate (block 504) the temperature control element (FIG. 1, 106) responsive to the measured temperature rising above a second threshold temperature. For example, the threshold temperature at which the controller (FIG. 1, 104) activates the heating element may be 10° C. In this example the threshold temperature at which the controller (FIG. 1, 104) deactivates the heating element may be 15° C. That is, once the thermal sensor (FIG. 1, 102) indicates that the hardware component (FIG. 2, 208) temperature is greater than 15° C., the controller (FIG. 1, 104) may deactivate (block 504) the heating element. Implementing a second, and different, threshold as a trigger to deactivate (block 504) the heating element may provide a buffer to account for a hardware component (FIG. 1, 106) potentially dropping in temperature following deactivation of the heating element.

In another example, the controller (FIG. 1, 104) may deactivate (block 504) the temperature control element (FIG. 1, 106) responsive to a compute device (FIG. 1, 100) boot operation. That is, once the compute device (FIG. 1, 100) has been booted, the hardware component (FIG. 2, 208) or other hardware components are activated, which may generate sufficient heat to maintain the hardware component (FIG. 2, 208) within the operational temperature range.

In any case, the method (500) may repeat. That is, measured temperature values for the hardware component (FIG. 2, 208) may continuously be compared to a respective threshold temperature. When the measured temperature is above the threshold temperature, a heating element may be deactivated. However, when the surrounding temperature drops and the hardware components (FIG. 2, 208) become inactive, the measured temperature may fall to be lower than the lower bound threshold. In this environment, the controller (FIG. 1, 104) may continue to compare the measured temperature to the threshold temperature and may selectively activate the heating element should the measured temperature fall below the threshold temperature.

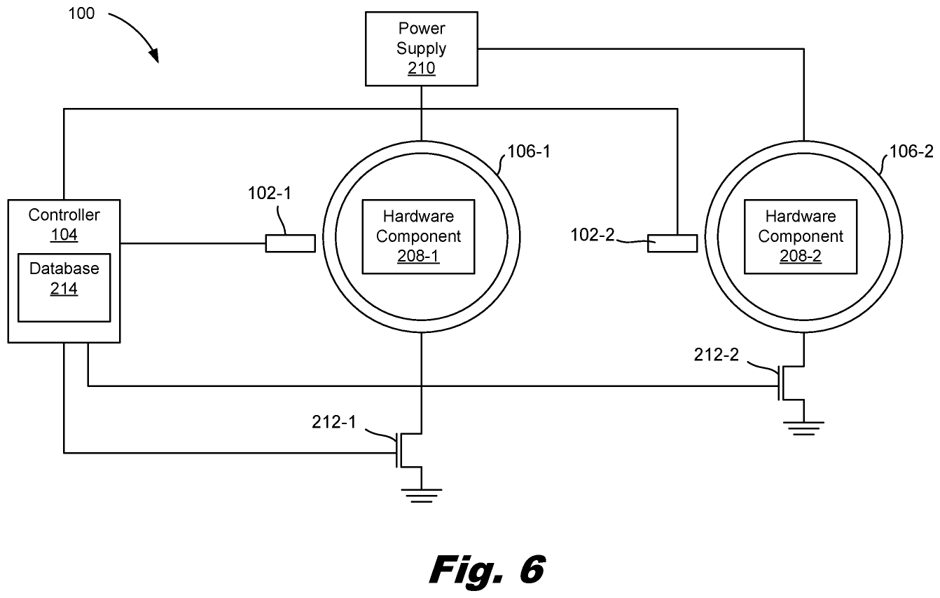

FIG. 6 is a diagram of a compute device (100) for hardware component (208-1, 208-2) temperature control, according to an example of the principles described herein. In the example depicted in FIG. 6, there are multiple hardware components (208-1, 208-2) to be controlled. In this example, the compute device (100) includes multiple temperature control elements (106-1, 106-2), each to control the temperature of a different hardware component (208). Specifically, a first temperature control element (106-1) may control the temperature of a first hardware component (208-1) while a second temperature control element (106-2) may control the temperature a second hardware component (208-2).

In a specific example, the temperature control elements (106) may be heating elements. In this example, the different heating elements may be individually activated, and in some examples at different temperature thresholds. For example, the controller (104) may close a first switch (212-1) to activate the first heating element, when an output of the first thermal sensor (102-1) indicates that the first hardware component (208-1) has a temperature of 10° C. By comparison, the controller (104) may close a second switch (212-2) to activate the second heating element, when an output of the second thermal sensor (102-1) indicates that the first hardware component (208-1) has a temperature of 15° C. In another example, the threshold temperatures that trigger activation of the respective heating elements may be the same. Similarly, the controller (104) may deactivate the respective heating elements at either the same threshold or different thresholds.

In any case, as the different hardware components (208) may cool down or heat up at different temperatures, independently controlled temperature control elements (106) provide for customized and flexible temperature control of different hardware components (208) found in a compute device (100).

As in the examples described above, the threshold temperatures that trigger activation or deactivation may be acquired by the controller (104) either through an internal database (214) or a remote database.

As each of the temperature control elements (106-1, 106-2) are independently activated, the power supply (210) may form independent electrical circuits with both the first temperature control element (106-1) and the second temperature control element (106-2). Also in this example, the compute device (100) may include different thermal sensors (102-1, 102-2), each to measure the temperature adjacent a corresponding hardware component (208-1, 208-2).

While FIG. 6 depicts a single hardware component (208) encompassed by a respective temperature control element (106), in some examples, multiple hardware components (208) may be encompassed by a single temperature control element (106). Accordingly, the compute device (100) provides zones of localized heating of hardware components (208) to ensure operation within a target temperature range.

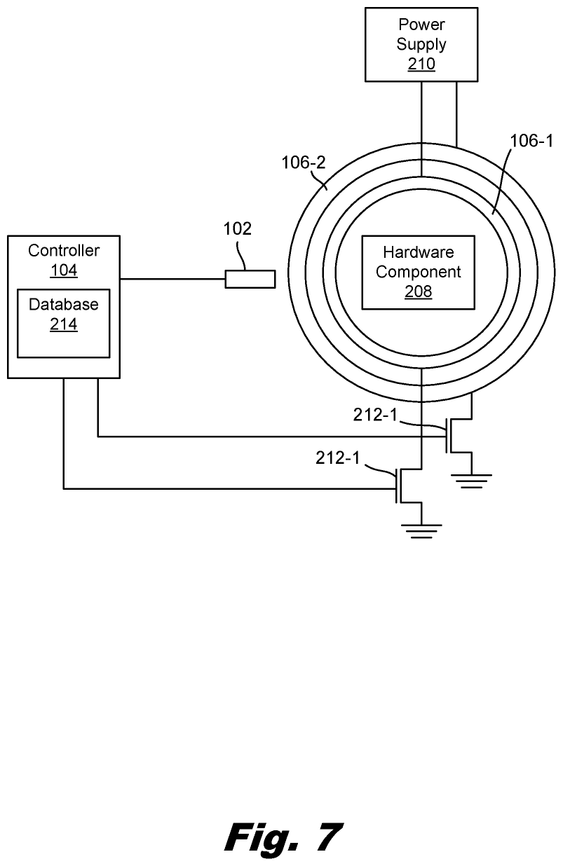

FIG. 7 is a diagram of a compute device (100) for hardware component (208) temperature control, according to an example of the principles described herein. Similar to the example of FIG. 6, FIG. 7 depicts an example where multiple temperature control elements (106-1, 106-2) are used, and independently controlled by the controller (104). Moreover, in this example, each temperature control element (106) may similarly be independently coupled to the power supply (210). However, in this example, the temperature control elements (106) are contiguous around a particular hardware component (208). As in the example depicted in FIG. 6, in the example depicted in FIG. 7, the temperature control elements (106-1, 106-2) may be activated at the same and/or different temperatures and may be individually controlled. Accordingly, in the example where the temperature control elements (106) are heating elements, the heating elements may be activated individually or simultaneously to provide a variety of heating rates to increase or maintain the hardware component (FIG. 2, 208) within its operational temperature range.

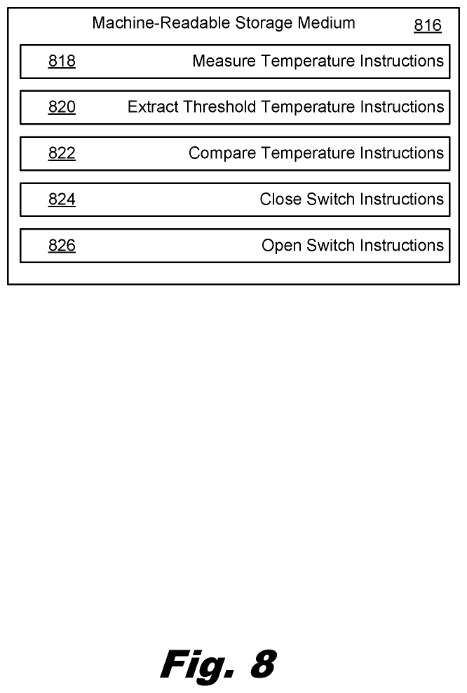

FIG. 8 depicts a non-transitory machine-readable storage medium (816) for controlling the temperature of a hardware component (FIG. 2, 208) in a compute device (FIG. 1, 100), according to an example of the principles described herein. To achieve its desired functionality, the controller (FIG. 1, 104) includes various hardware components. Specifically, the controller (FIG. 1, 104) includes a processor and a machine-readable storage medium (816). The machine-readable storage medium (816) is communicatively coupled to the processor. The machine-readable storage medium (816) includes a number of instructions (818, 820, 822, 824, 826) for performing a designated function. In some examples, the instructions may be machine code and/or script code.

The machine-readable storage medium (816) causes the processor to execute the designated function of the instructions (818, 820, 822, 824, 826). The machine-readable storage medium (816) can store data, programs, instructions, or any other machine-readable data that can be utilized to operate the controller (FIG. 1, 104). Machine-readable storage medium (816) can store machine readable instructions that the processor of the controller (FIG. 1, 104) can process, or execute. The machine-readable storage medium (816) can be an electronic, magnetic, optical, or other physical storage device that contains or stores executable instructions. Machine-readable storage medium (816) may be, for example, Random-Access Memory (RAM), an Electrically Erasable Programmable Read-Only Memory (EEPROM), a storage device, an optical disc, etc. The machine-readable storage medium (816) may be a non-transitory machine-readable storage medium (816).

Referring to FIG. 8, measure temperature instructions (818), when executed by the processor, cause the processor to, measure a temperature in a zone adjacent a hardware component (FIG. 2, 208) of a compute device (FIG. 1, 100). Extract threshold temperature instructions (820), when executed by the processor, cause the processor to, extract a threshold temperature for the hardware component (FIG. 2, 208) from a database (FIG. 2, 214). Compare temperature instructions (822), when executed by the processor, cause the processor to, compare a measured temperature against the threshold temperature for the hardware component (FIG. 2, 208). Close switch instructions (824), when executed by the processor, cause the processor to, responsive to the measured temperature being below a lower bound threshold temperature for the hardware component (FIG. 2, 208), close a switch (FIG. 2, 212) to couple a heating element to a power supply (FIG. 2, 210) to generate a current through the heating element to raise the temperature of the hardware component (FIG. 2, 208). Open switch instructions (826), when executed by the processor, cause the processor to, responsive to the measured temperature rising above the threshold temperature for the hardware component (FIG. 2, 208), open the switch (FIG. 2, 212) to decouple the heating element from the power supply (FIG. 2, 210) to stop the current.

In summary, using such a compute device, method, and machine-readable storage medium may, for example, 1) ensure hardware components are within a target temperature range; 2) provide remote activation of a remote compute device; and 3) maintain hardware components within the target temperature range even when the compute device is in a sleep state. However, it is contemplated that the compute devices disclosed herein may address other matters and deficiencies in a number of technical areas, for example.

What is claimed is:

1. A compute device, comprising:
a thermal sensor to measure a temperature at a hardware component of the compute device;
a controller to:
determine a threshold temperature for the hardware component; and
responsive to a measured temperature being beyond the threshold temperature for the hardware component, activate a temperature control element adjacent the hardware component; and
the temperature control element adjacent the hardware component to control the temperature of the hardware component.

2. The compute device of claim 1:
further comprising a switch to couple the temperature control element to a power supply; and
wherein the controller is to activate the temperature control element by closing the switch between the temperature control element and the power supply.

3. The compute device of claim 2, wherein the power supply, thermal sensor, and controller are active when the compute device is in a sleep state.

4. The compute device of claim 1, wherein the temperature control element surrounds the hardware component.

5. The compute device of claim 1, wherein the hardware component is:
an embedded controller;
a system on a chip (SoC) circuit;
a super input/output (SIO) circuit;
a graphics processor;
a central processing unit (CPU);
a network interface card (NIC); or
a memory device.

6. The compute device of claim 1, wherein the temperature control element is a is a thin film resistor disposed on a substrate.

7. The compute device of claim 1, further comprising a database on the controller to store the threshold temperature for the hardware component.

8. The compute device of claim 1, wherein the controller is to extract the threshold temperature for the hardware component from a remote database.

9. The compute device of claim 1, wherein the compute device is to connect to an output device and input device remote from the compute device.

10. A method, comprising:
measuring, with a thermal sensor, a temperature in a zone adjacent a hardware component of a compute device;
comparing, with a controller, a measured temperature against a threshold temperature for the hardware component; and
responsive to the measured temperature being beyond the threshold temperature for the hardware component, activating, with the controller, a temperature control element adjacent the hardware component.

11. The method of claim 10, further comprising deactivating, with the controller, a heating element responsive to the detected temperature rising above the threshold temperature.

12. The method of claim 10, further comprising deactivating, with the controller, a heating element responsive to a compute device boot operation.

13. A non-transitory machine-readable storage medium encoded with instructions executable by a processor, the machine-readable storage medium comprising instructions to, when executed by the processor, cause the processor to:
measure a temperature in a zone adjacent a hardware component of a compute device;
extract a threshold temperature for the hardware component from a database;
compare a measured temperature against the threshold temperature for the hardware component;
responsive to the measured temperature being below the threshold temperature for the hardware component, close a switch to couple a heating element to a power supply to generate a current through the heating element to raise the temperature of the hardware component; and
responsive to the temperature rising above the threshold temperature for the hardware component, open the switch to decouple the heating element from the power supply to stop the current.

14. The non-transitory machine-readable storage medium of claim 13, wherein the threshold temperature is:
a lower bound temperature of an operational temperature range for the hardware component; or
a buffered lower bound temperature of an operational temperature range for the hardware component.

15. The non-transitory machine-readable storage medium of claim 13, wherein the threshold temperature is an upper bound temperature of an operational temperature range for the hardware component.
